(19) United States
(12) Patent Application Publication
(10) Pub. No.: US 2014/0156272 A1
(43) Pub. Date: Jun. 5, 2014

(54) VOICE ENTRY VIN METHOD AND APPARATUS

(71) Applicants: Joseph M. Sieger, Barrington, IL (US); Samip H. Jani, Westmont, IL (US); Michael P. Myers, Naperville, IL (US); Sharada Rajaraman, Aurora, IL (US); Ramya Dubbudu, Schaumburg, IL (US); June Lee, Rolling Meadows, IL (US); Saurin Travadi, Chicago, IL (US); Anthony J. Roth, Chicago, IL (US)

(72) Inventors: Joseph M. Sieger, Barrington, IL (US); Samip H. Jani, Westmont, IL (US); Michael P. Myers, Naperville, IL (US); Sharada Rajaraman, Aurora, IL (US); Ramya Dubbudu, Schaumburg, IL (US); June Lee, Rolling Meadows, IL (US); Saurin Travadi, Chicago, IL (US); Anthony J. Roth, Chicago, IL (US)

(73) Assignee: INSURANCE AUTO AUCTIONS, INC., Westchester, IL (US)

(21) Appl. No.: 14/090,866

(22) Filed: Nov. 26, 2013

Related U.S. Application Data
(60) Provisional application No. 61/731,156, filed on Nov. 29, 2012.

(51) Int. Cl. G10L 15/26; G06F 17/27

(52) U.S. Cl. CPC G10L 15/26; G06F 17/2765
USPC 704/235

(57) ABSTRACT

A mobile electronic device such as a smart phone receives a spoken vehicle identification number (VIN) by a user. The smart phone device interprets the spoken input as interpreted text. The device removes any spaces, punctuation, words, or sound-alike words from the interpreted text. The device replaces any prohibited characters with corresponding acceptable letters. The device displays the resulting character string as a VIN to the user for comparison to the VIN on a vehicle. The device may communicate to a database to obtain make, model, and model year information corresponding to the VIN and display that vehicle information to the user for confirmation.

### CROSS-REFERENCE TO RELATED APPLICATION

This application claims the benefit of U.S. Provisional Patent Application Ser. No. 61/731,156, filed Nov. 29, 2012, which is incorporated herein by reference.

### BACKGROUND OF THE INVENTION

1. Field of the Invention

The present invention relates generally to a data entry method and apparatus for entering an identification number or code into a device, and more particularly to method and apparatus for voice entry of an identification number or code, serial number, part number or the like into a device such as a portable computer device.

2. Description of the Related Art

Automobiles and other vehicles are uniquely identified by a vehicle identification number, also referred to as a VIN. The VIN has been standardized to be a 17 digit sequence that includes letters and numbers. With the correct VIN, it is possible to learn a vehicle's make, model, model year, country of manufacture, as well as the history of the vehicle such as major repairs performed on the vehicle and whether the vehicle has been damaged in an accident, flood, or fire. The VIN information is commonly marked on a tag fastened behind a lower edge of the vehicle windshield, as well as at other locations such as on the door frame or door post, on the engine, on the engine compartment firewall, on the wheel arch, on the steering column, and/or on the radiator support bracket.

Industries that deal with a large number of vehicles, such as vehicle auction services, need to correctly enter the VIN information into tracking systems so as to monitor the location and disposition of each vehicle. Best practices demand that the VIN information is recorded each time the vehicle is moved and as frequently as once per day even if the vehicle is not moved. Currently, VIN information is recorded by a user locating a VIN tag affixed to the vehicle and writing the VIN information onto a paper form, or by entering the VIN information via a keypad into a data recording or storage device. This can lead to errors in entering the VIN information or in transcribing the VIN and thus misidentification of the vehicle, particularly when large numbers of vehicles are being checked on a frequent basis. But more importantly, it is time consuming. Inventorying a large number of vehicles can occupy a significant number of employee-hours.

Another possible means for tracking vehicles is to use an optical scanner to scan an optical code that corresponds to the vehicle identification number. Some newer vehicles by certain makers include bar codes that can be read by an optical scanner, but many older vehicles or vehicles by other makers lack such codes. Even for those vehicles that include optical codes, an optical scanner may not be able to successfully read a vehicle identifier if the identifier is obscured by frost, rain, snow, or dirt on the windshield, cracks in the windshield or other factors. The condition of the vehicle damaged as a result of a fire or flood or severe accident may be such that optical scanning of the VIN information is not effective.

Each year, several million vehicles are damaged in accidents or by floods or fires. The owner of the vehicle or the insurance company that insures the vehicle may determine that the cost of repairing the damaged vehicle is sufficiently large that the vehicle will not be repaired but will be sold for salvage. A vehicle auction company acquires the vehicle from the vehicle owner or from the insurance company, transfers the vehicle to an auction site and then offers the damaged vehicle up for auction. The vehicles can span a wide range of ages and makes and so many of the vehicles will lack an optical scan code, rendering efforts to read VIN information by optical scanners largely ineffective. Nevertheless, it is still necessary to track each vehicle and recording the VIN is the most effective way of doing so.

Devices, such as some smart phones and tablet computers, are available to receive user input and to communicate wirelessly, making them an ideal tool for entering and transmitting VIN information from a wide range of locations. Entry of the VIN information via the device's keypad or touch screen can be time consuming due to the small size of the keypad and can easily result in errors. Some smart phone devices incorporate voice-to-text conversion functions. An example of a voice-to-text input function is Siri, a voice to text conversion function included in some Apple iPhone devices running the iOS operating system. Voice command functions are also available for smart phones running the Android operating system. However, when such voice-to-text functions are used to input sequences of numbers and/or letters, the voice-to-text conversion may convert the sequence incorrectly. For example, one or more of the spoken numbers and letters may be converted into words rather than the numbers or letters. For example, the user speaks “3” and the text conversion types it as the word “three” or the user speaks “C” and the text conversion types it as “see” or “sea.” The voice-to-text conversion may convert a spoken sequence of numbers and letters into a text sequence that includes spaces, hyphens or other punctuation between the numbers and letters. For example, the user may recite a string numbers and the conversion function interprets the number string as a telephone number and adds parenthesis and hyphens so that it is in a telephone number format. The user may recite a letter and number sequence and the text conversion may type it as a sequence including a mix of words, spaces, punctuation, letters, numbers, or other text characters or elements. At best, the voice entry systems are inconsistent in their treatment of recited number and letter strings.

### SUMMARY OF THE INVENTION

The present invention provides a voice entry system and method by which a user may enter a vehicle identification number (VIN) into a computer device such as a smart phone or other device. The computer device or other device operates to receive spoken information from a user and perform a voice-to-text conversion. When a user orally recites a vehicle identification number (VIN) to the device, the device determines that the sequence of spoken words from the user is a VIN rather than a telephone number, word sequence, or other information. The device formats the text as a VIN by presenting the information as a sequence of numbers and letters without spaces, hyphens or other punctuation. The VIN as understood by the device is displayed so that the user may compare it to the VIN information observed on the vehicle. VIN information can thereby be quickly and correctly entered via the device for vehicle tracking.

The computer device or other device used in the method is preferably portable and includes a display so that the user may bring the device to the vehicle, read aloud the VIN information from VIN tag on the vehicle, view the interpreted letter and number sequence shown on the display of the device, and compare the displayed letter and number sequence to the VIN on the vehicle. If the correct VIN is shown, the user may confirm the text sequence and move on to the next vehicle for entry of the next VIN. In an optional configuration, as a further verification of correct entry of the VIN, the device communicate wirelessly to a database or network in which is stored vehicle information and may retrieve and the make, model, model year, and/or other information about the vehicle that corresponds to the VIN. The user can compare the characteristics of the vehicle to the information retrieved from the database or network as further assurance that the vehicle is being correctly identified, in other words, that a correct VIN has been read into the device by the user and that the device has correctly interpreted by the voice input.

The present system and method has utility not only for vehicle auction services but also for insurance companies, vehicle rental companies, new or used vehicle sales companies, vehicle towing services, vehicle repair shops, or other entities having a need to identify a vehicle. The principles of the voice entry VIN system may also be used to input other information as well, such as stock numbers, serial numbers, part numbers, ticket numbers, or other information in a wide range of industries, services, or situations.

For example, a vehicle, machine, product, component, or other item may be referenced by a stock number or serial number. The stock number or serial number may have a predetermined number of characters or a particular format or configuration. The present method may be configured to recognize the stock number or serial number from a spoken sequence and correctly identify the spoken words as the stock number or serial number. Inventories of items or other procedures requiring entry of the stock number or serial number are greatly facilitated. The voice entry system facilitates hands free operation, such as for disabled persons, or in emergency situations such as for emergency response personnel or at a medical facilities where text sequences (patient numbers, part numbers, location identification, or the like) may need to be entered by spoken commands.

The computer device or other spoken command receiving device may be running program that receives and processes vehicle identification information, such a vehicle information application or app. The program may display a user interface requesting input of vehicle information. In a preferred embodiment, the user interface displays a request for the user to input vehicle identifying information into the device. The program enables the voice command function of the device to receive the spoken input from the user as the user reads aloud the VIN of the vehicle. The application also may accept other spoken input such as the make, model, color or other characteristic of the vehicle. It is foreseeable that the system may be able to identify a vehicle if a portion of the VIN is missing as a result of damage to the vehicle, for example by the user reciting the portion of the VIN that is present and reciting further information on the vehicle to obtain vehicle identification or at least narrow the possible choices.

### BRIEF DESCRIPTION OF THE DRAWINGS

FIG. 1 is a flow chart showing an overview of the process for speech to VIN information conversion according to the principles of the present invention;

FIG. 2 is a flow chart showing the speech to VIN information of FIG. 1 in further detail;

FIG. 3 is a front view of a smart phone device showing a voice entry screen on the display of the device for processing the voice entry according to the present invention;

FIG. 4 is a front view of the smart phone device of FIG. 3 that shows on the display a result of processing a spoken VIN; and

FIG. 5 is a system diagraph of a system that incorporates a mobile device that performs a method according to the principles of the present invention.

### DETAILED DESCRIPTION OF THE PREFERRED EMBODIMENTS

The present method and apparatus provides speech to text conversion where the text is to be formatted to a particular purpose. The text preferably is a sequence of letters and/or numbers that are used as a reference. One example of the text is a vehicle identification number or VIN used to uniquely identify a vehicle. Other examples of text may include stock numbers, part numbers, series numbers, file numbers, identification numbers, or other sequences of numbers and/or letters to are to be input into a system. The system could also be used for data input, for input of call letters or other number and/or letter sequences.

The input of the text according to a preferred embodiment is by speech input where the user speaks into a microphone or other speech detector. Other input to the system could be provided as well. The microphone or other speech detector of a preferred embodiment is a microphone of a mobile device, such as a smart phone, personal data assistant (PDA), tablet computer, telephone, cell phone, or other device. The microphone or speech detector may be provided on a personal computer, laptop computer, netbook computer, notebook computer, kiosk, workstation, or other device or as a separate or integrated microphone or other sound or speech detecting device.

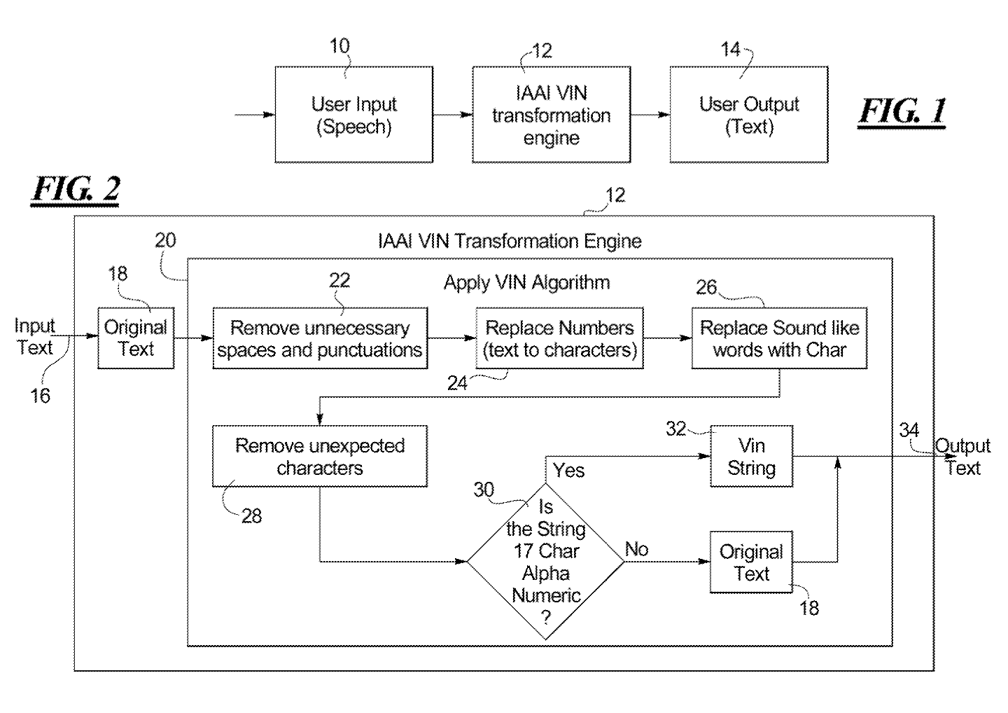

Referring to FIG. 1, a user speaks so that the microphone or other sound detecting device can detect the spoken information, as indicated at block 10. The user may use voice input to the system for inputting a variety of information or for querying the device or requesting that a function be performed. In a system for identifying and tracking vehicles, the user may use voice input to indicate the make, model, model year, and other information relating to a vehicle. The user may use voice input to indicate names, address information, telephone numbers, or other information. This information is treated in the ordinary way by converting the speech to text according to known methods. However, when the user uses voice input to indicate VIN information of a vehicle, the method and system detects that a VIN is being spoken and activates a VIN transformation engine, as indicated in block 12. The VIN transformation engine performs an interpretation of the spoken information and from that spoken information generates a sequence of text symbols corresponding to the spoken information. The sequence of text symbols is formatted according to the standards for a VIN. After completing the transformation of the speech to text, the method and system outputs the VIN formatted text as user output, as indicated at block 14.

Turning to FIG. 2, a device that includes a speech to text system, also referred to as a speech recognition system, has the VIN transformation engine 12 on the device. The user activates the speech recognition system of the device and speaks into the microphone. The activation of the speech recognition system also activates the VIN transformation engine 12 as an active process in one embodiment. In other embodiments, the VIN transformation engine 12 may remain inactive and is only activated at predetermined stages of an information input process, for example, at a step in an information input process where the system is expecting a VIN as the input.

The spoken information by the user may be a VIN or may be some other information. The speech recognition system converts the speech to text and provides the text as input to the VIN transformation engine 12, at 16. The original text 18 enters the transformation engine 12, where it is provided to a VIN algorithm or process 20. As will be noted below, a copy of the original text as interpreted by the speech recognition system is saved in the device. At a first step 22 as performed by the algorithm or process 20, spaces and punctuations are removed from the text string. A VIN has no spaces or punctuation and so these are characterized as unnecessary by the algorithm or process 20. For example, if the speech to text recognition system has interpreted the spoken text string as a telephone number and inserted dashes, parenthesis, and/or spaces, these non-VIN elements are removed.

In step 24, any numbers that have been interpreted as words are converted to the corresponding number. For example, the text recognition system may have interpreted the spoken information as the words “one,” or “seven,” or “nine.” At block 24, the process replaces these with the numerals “1,” “7,” or “9.” Of course, all numbers are transformed, including combined numbers such as “eleven”→“11”, “twenty-three”→“23”, etc. Also considered is that the user may speak different words for a numeric “0” or “Ø,” including “zero,” “oh” or others. These are translated to the corresponding numeral.

The next step 26 replaces sound-alike words with characters. The speech to text recognition system may interpret the spoken information as words rather than character strings. Examples of sound-alike words that may appear in the output of the speech recognition system and their replacements for purposes of VIN transformation are:
sea→C
see→C
are→R
you→U
why→Y
and→N
jay→J
bee→B
be→B
   Of course, other sound-alike words are possible and will be included in the system. The system preferably includes words that while not exact sound-alikes, such as “are” and “R,” are similar in sound, such as “and” and “N.” Other similar sounding words are also included.

Moving next to step 30, the method determines whether the character string is a VIN. The standardized VIN is 17 characters in length, is alpha-numeric, and does not have an I (capital i) or Q. If the character string is more than or less than 17 characters, it is not interpreted as a VIN. If it is not alpha-numeric, it is not interpreted as a VIN. The characters I (capital i) and Q are not used in VIN information due to the likelihood that an I (capital i) could be confused for a 1 (one), or a Q could be confused for an O. The presence of an I or a Q in the character sequence is an indicator that the sequence is not a VIN. As such, if it includes the an I or a Q, it is not interpreted as a VIN. If the character string meets all of these tests, it is interpreted as a VIN.

If the outcome of the decision block 30 is a determination that the converted speech is a VIN, the method moves to block 32 where the VIN string is recognized as such by the system and is output to the user as a VIN at 34. If the decision block 30 determines that the character string is not a VIN, the original text 18, which was saved in a preceding step, is output to the user.

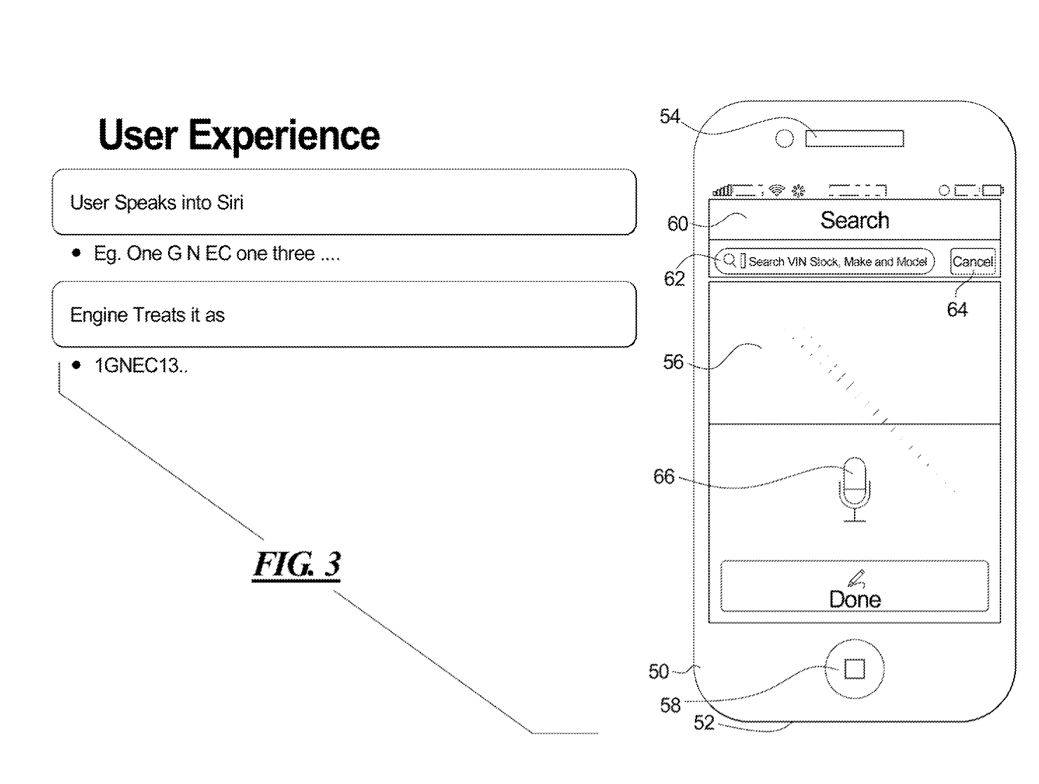

An example of an application of the present method and apparatus is shown in FIG. 3. A mobile device such as a smart phone 50 is provided with an application, also referred to as an “app,” that includes the VIN transformation engine. The user wishes to speak a word sequence into the microphone of the smart phone corresponding to the VIN of a vehicle, such as by reading the VIN information from a tag on the vehicle. For example, the user may be performing an inventory of a vehicle lot, or the user may be a tow truck driver preparing to tow a vehicle from a roadside or other location. The user may be tracking vehicles in transit, such as vehicles being transferred by truck, rail or ship. The user may be monitoring vehicles entering or leaving a vehicle rental facility. Countless other uses are encompassed within this invention as well.

In the illustrated example, the smart phone is an Apple iPhone 50 that includes a microphone 52, speaker 54, touch screen display 56, and control button or home button 58. Other features, such as a camera lens, volume controls, data input, headphone jack, etc. may be present but are not utilized in the present method. The display screen shows that a search 60 is being requested, potentially by a vehicle tracking program that receives as its input VIN information and possibly other information on vehicles to be tracked. The cursor is in a search input field 62. Displayed in the search input field 62 is the text “Search VIN, Stock, Make and Model”—indicating that the user may input any of these items of information. A cancel button 64 is provided on the touch sensitive display so that the user may cancel out of the search function. A voice entry system has been activated on the device 50, as indicated by a microphone symbol 66. A “done” button 68 is provided on the touch sensitive screen for activation by the user when the user has finished speaking the information and wishes to have the spoken information converted to text.

In the Apple iPhone, the speech recognition system is known as Siri. The Siri system receives the spoken words of the user and provides the resulting text to the VIN transformation engine as shown in FIG. 2. An example is provided in FIG. 3 wherein the user speaks “One G N EC one three . . . ” The output of the transformation engine provides “1GNEC13 . . . ” The system uses only permitted characters and removes prohibited characters.

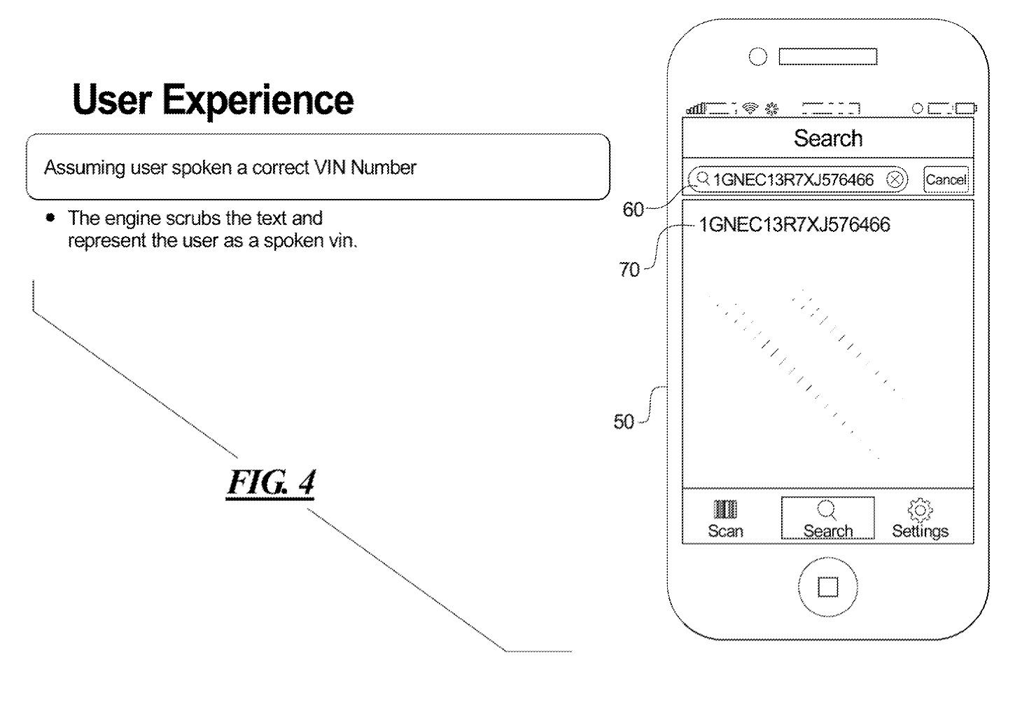

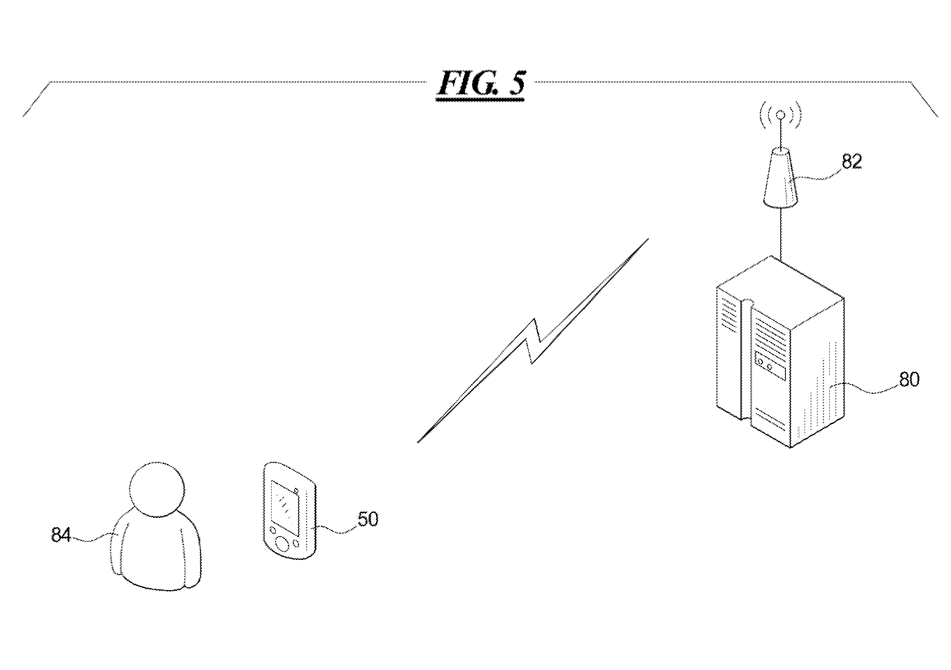

FIG. 4 shows the smart phone 50 in which the voice recognition system and transformation engine have determined that the spoken word string represents a vehicle identification number (VIN) and has displayed the translated VIN in the search field 60. The VIN is also displayed on the screen portion 70 below the search field 60 in the illustrated example. The user may compare the displayed VIN to the VIN information on the vehicle to determine if it is accurate. If the user finds the displayed VIN to be accurate, the user may select another function, such as displaying the vehicle information (make, model, model year, for example) that corresponds to the VIN. In this way, the user may compare the vehicle characteristics to the vehicle as a further assurance that the correct VIN has been entered.

Where vehicles are also identified by a stock number, the preferred embodiment also permits the user to speak the stock number of the vehicle into the voice recognition system. The same principles apply for the stock number as for the VIN determination. The allowed and prohibited characters of the stock number, the expected number of characters, and the formatting of the stock number is used to transform the spoken input into a correctly formatted stock number. The same transformation engine 20 could be used to provide the stock number as for the VIN information, or a second transformation engine tailored to transforming stock numbers could be provided in the device for processing the stock number. The user can thereby compare the displayed stock number to the stock number displayed on the vehicle and verify that a correct entry has been made.

The preferred embodiment also permits the user to provide other information about the vehicle as a means for identifying the vehicle. The make and model of the vehicle may be entered by spoken word entry. The text to voice recognition system interprets the spoken words without using the transformed output of VIN transformation engine. In particular, the VIN transformation engine determines as step 30 that the text is not a YIN and as a result outputs the original text 18 for verification by the user and for use by the search engine.

It is also possible that the spoken word entry by the user may be garbled or jumbled words. The user may try speaking the VIN information again or may choose an alternate entry method for the VIN or stock number information. For example, the user may may select manual entry of the VIN or stock number information using a keypad entry on the touch screen of the device, for example. This alternate entry may be useful where the user is in a noisy environment such as near a busy roadway or near active machinery. The system can again be used for voice entry of the information when the noise subsides, or the user can try speaking the information again more closely to the microphone or more distinctly.

As shown in FIG. 5, the smart phone 50 may store the VIN information internally and/or may wirelessly transmit the VIN information to a central storage system 80, shown here as a server. The central storage system 80 may record the vehicle location or other information using the location system of the smart phone 50, such as the GPS information or information on utilized cell towers 82 or other location systems. The user 84 may photograph the vehicle using the smart phone camera for uploading the image to the central system 80. Alternately, the central system 80 may download an image of the vehicle corresponding to the VIN to the smart phone upon successful entry of the VIN. The central storage system 80 may contain the vehicle characteristics that correspond to the VIN so that when a VIN has been successfully entered into the smart phone 50 and transmitted to the central storage system 80, the central storage system 80 returns the vehicle characteristics such as model, make, model year, and the like.

The central storage system 80 may be replaced by distributed data storage, or by the cloud, or by other information sources, such as the internet. The transmittal of the VIN information may be performed wirelessly via a mobile telephone or data system, via WiFi or other wireless communication protocol, or may be transferred via wired communication. For example, the user may periodically plug the mobile device into a connector for transfer of the collected VIN information to a central storage system or other storage.

A user seeking to inventory a large number of vehicles need only activate the vehicle inventory function on the smart phone, read the VIN information of each vehicle into the microphone of the smart phone, and verify that the VIN information is interpreted correctly by the transformation engine before moving to the next vehicle. Large numbers of vehicles can be accurately tracked in a relatively short time using the present method and system.

The examples set forth herein describe a voice entry system using the English language for voice entry. It is within the scope of this invention to provide a voice entry system in Spanish, French, German, or other languages. It is also foreseen to provide a voice entry system that interprets voice entries in two or more languages simultaneously. For example, a bi-lingual user may speak the letters and numbers of the VIN or other information in either language. Different dialects or accents in the spoken entry are also accommodated in some embodiments of the present invention.

The voice entry of the VIN or other information may be provided at a kiosk, check in or check out station for vehicles or other items, at PC or other computer device, via telephone, or by other communication channels to a voice recognition system.

Although other modifications and changes may be suggested by those skilled in the art, it is the intention of the inventors to embody within the patent warranted hereon all changes and modifications as reasonably and properly come within the scope of their contribution to the art.

We claim:

1. A method for input of a vehicle identification number into a system, comprising the steps of:
in a computer device, receiving a spoken input from a user;
in a computer device, interpreting the spoken input as interpreted text;
in a computer device, saving a copy of the interpreted text;
in a computer device, removing any spaces and punctuation from the interpreted text;
in a computer device, replacing any words with corresponding letters or numbers;
in a computer device, replacing any sound-alike words with corresponding letters or numbers; and
in a computer device, displaying a resulting text string to a user.

2. A method as claimed in claim 1, wherein the spoken input from the user includes a vehicle identification number (VIN) of a vehicle.

3. A method as claimed in claim 2, further comprising:
in a computer device, storing the VIN of the vehicle in database containing vehicle information of a plurality of vehicles.

4. A method as claimed in claim 2, further comprising:
in a computer device, retrieving information about the vehicle using the VIN to identify the vehicle.

5. A method as claimed in claim 4, wherein the retrieved information about the vehicle includes vehicle make, model, and model year information.

6. A method as claimed in claim 5, further comprising:
in the computer device, displaying the vehicle make, model, and model year information to the user.

7. A method as claimed in claim 1, further comprising:
in a computer device, receiving a confirmation from a user that the displayed text string corresponds to the spoken input of the user.

8. A method as claimed in claim 1, wherein the computer device is a mobile communication device.

9. A method as claimed in claim 8, wherein the mobile computer device is a device selected from the group comprising: a mobile telephone, a table computer, a personal digital assistant, a portable computer device, and a smart phone.

10. A method as claimed in claim 1, wherein the vehicle identification number has characters from a predetermined set of characters and has a predetermined number of characters; and
the step of displaying the resulting text string includes displaying a text string containing only the predetermined number of characters and displaying the text string containing only characters from the predetermined set of characters.

11. A method as claimed in claim 1, further comprising:
in the computer device, removing prohibited characters from the displayed text string.

12. A method for input of a vehicle identification number into a system, comprising the steps of:
in a computer device, receiving a spoken input from a user, the spoken input including a vehicle identification number (VIN) of a vehicle;
in a computer device, interpreting the spoken input as interpreted text;
in a computer device, removing any spaces and punctuation from the interpreted text;
in a computer device, replacing any words in the interpreted text with corresponding letters or numbers;
in a computer device, replacing any sound-alike words in the interpreted text with corresponding letters or numbers;
in a computer device, removing any prohibited characters from the interpreted text;
in a computer device, displaying a resulting text string to a user as a VIN of the vehicle; and
in a computer device, receiving a confirmation from the user that the displayed VIN is correct.

13. A method for input of an identification character string into a system, comprising the steps of:
in a computer device, receiving a spoken input from a user, the spoken input including a spoken identification character string;
in a computer device, interpreting the spoken input as interpreted text;
in a computer device, removing any spaces and punctuation from the interpreted text;
in a computer device, replacing any words in the interpreted text with corresponding letters or numbers;
in a computer device, replacing any sound-alike words in the interpreted text with corresponding letters or numbers; and
in a computer device, displaying a resulting character string to a user.

14. A method as claimed in claim 13, further comprising;
in a computer device, replacing forbidden characters in the interpreted text with corresponding acceptable characters.

15. A system for entry of vehicle identification information, comprising:
a mobile electronic device having a processor and a microphone and a computer readable memory and a wireless communication module and a display;
a remote server on which is stored vehicle information corresponding to vehicle identification information;
the mobile electronic device being programmed to:
receive spoken vehicle identification information,
interpret the spoken input as interpreted text;
remove any spaces and punctuation from the interpreted text;
replace any words in the interpreted text with corresponding letters or numbers;
replace any sound-alike words in the interpreted text with corresponding letters or numbers; and
display a resulting character string to a user as the vehicle identification information;
the mobile device communicating with the remote server via wireless communication to obtain and display vehicle information of a vehicle in response to the character string of vehicle identification information.
